(19) United States
(12) Patent Application Publication
(10) Pub. No.: US 2024/0107581 A1
(43) Pub. Date: Mar. 28, 2024

(54) COMMUNICATION APPARATUS, COMMUNICATION METHOD, AND STORAGE MEDIUM

(71) Applicant: CANON KABUSHIKI KAISHA, Tokyo (JP)

(72) Inventor: RYO WATANABE, Tokyo (JP)

(21) Appl. No.: 18/534,404

(22) Filed: Dec. 8, 2023

Related U.S. Application Data
(63) Continuation of application No. PCT/JP2022/021204, filed on May 24, 2022.

(30) Foreign Application Priority Data
Jun. 9, 2021 (JP) 2021-096516

(51) Int. Cl. H04W 74/08

(52) U.S. Cl. CPC H04W 74/0808; H04W 84/12

(57) ABSTRACT

A communication apparatus includes a communication unit capable of performing communication of a wireless frame using a first frequency channel and communication of a wireless frame using a second frequency channel in parallel, and a transmission unit configured to transmit information to another communication apparatus, the information indicating a distance between the first frequency channel and the second frequency channel on a frequency axis, the information indicating a channel distance necessary for performing transmission of the wireless frame using the first frequency channel and reception of the wireless frame using the second frequency channel in parallel in the communication by the communication unit.

### CROSS-REFERENCE TO RELATED APPLICATIONS

This application is a Continuation of International Patent Application No. PCT/JP2022/021204, filed May 24, 2022, which claims the benefit of Japanese Patent Application No. 2021-096516, filed Jun. 9, 2021, both of which are hereby incorporated by reference herein in their entireties.

### BACKGROUND OF THE INVENTION

### Field of the Invention

The present invention relates to a wireless communication technique.

### Background Art

With recent increases in the amount of data to be communicated, the development of communication techniques, such as a wireless local area network (LAN), has been advancing. The Institute of Electrical and Electronics Engineers (IEEE) 802.11 standard series is known as major communication standards for wireless LANs. The IEEE 802.11 standard series includes standards, such as IEEE 802.11a/b/g/n/ac/ax. For example, the latest standard IEEE 802.11ax standardizes a technique for improving communication speeds in congested situations in addition to providing a high peak throughput of up to 9.6 gigabits per second (Gbps) using orthogonal frequency-division multiple access (OFDMA) (see PTL 1).

The IEEE 802.11be standard is being standardized as a successor aiming at a further improvement in throughput, improved frequency use efficiency, and improved communication latency.

IEEE 802.11be discusses multi-link communication where an access point (AP) establishes a plurality of links with a station (STA) in frequency bands, such as 2.4 GHz, 5 GHz, and 6 GHz, and performs simultaneous communication. Some APs and STAs are unable to perform a reception operation on another link while performing a transmission operation on a predetermined link in multi-link communication due to hardware constraints of the wireless communication apparatuses. Measures concerning such APs and STAs are being discussed.

### CITATION LIST

### Patent Literature

PTL 1: Japanese Patent Application Laid-Open No. 2018-50133

For efficient multi-link communication, information indicating which link is capable of simultaneous transmission and reception with another link is desirably shared between the apparatuses to communicate. The reason is that if a pair of links not capable of simultaneous transmission and reception is used, the communication efficiency drops since the transmission processing and the reception processing are performed exclusively of each other. However, it has heretofore been not specifically defined what kind of information to share or how to share in order for the apparatuses to share information indicating which link is capable of simultaneous transmission and reception with another link.

### SUMMARY OF THE INVENTION

The present invention is directed to enabling communication apparatuses to efficiently share information about whether a channel pair is capable of simultaneous transmission and reception during multi-link communication, so that the apparatuses can perform efficient multi-link communication.

According to an aspect of the present invention, a communication apparatus includes a communication unit configured to perform communication of a wireless frame using a first frequency channel and communication of a wireless frame using a second frequency channel in parallel, and a transmission unit configured to transmit information to another communication apparatus, the information indicating a distance between the first frequency channel and the second frequency channel on a frequency axis, the information indicating a channel distance for performing transmission of the wireless frame using the first frequency channel and reception of the wireless frame using the second frequency channel in parallel in the communication by the communication unit.

According to another aspect of the present invention, a communication apparatus includes a communication unit configured to perform communication of a wireless frame using a first frequency channel and communication of a wireless frame using a second frequency channel in parallel, and a reception unit configured to receive information from another communication apparatus, the information indicating a distance between the first frequency channel and the second frequency channel on a frequency axis, the information indicating a channel distance for performing transmission of the wireless frame using the first frequency channel and reception of the wireless frame using the second frequency channel in parallel in the communication by the communication apparatus.

Further features of the present invention will become apparent from the following description of exemplary embodiments with reference to the attached drawings.

### BRIEF DESCRIPTION OF THE DRAWINGS

FIG. 1 is a diagram illustrating a configuration of a network according to the present invention.

FIG. 2 is a diagram illustrating a hardware configuration of a communication apparatus according to the present invention.

FIG. 3 is a block diagram illustrating a functional configuration of the communication apparatus according to the present invention.

FIG. 4 is a sequence diagram where channel distances between simultaneous transmit and receive (STR)-capable links on association candidate channels are notified using an Association Response frame according to a first exemplary embodiment.

FIG. 5 illustrates a configuration example of an Association Response frame that an access point (AP) transmits to a station (STA) according to the first exemplary embodiment.

FIG. 6 is a flowchart for determining an STR-capable channel distance for 20-MHz transmission.

FIG. 7 is a flowchart where the AP determines whether a pair of channels A and B is STR-capable during 20-MHz transmission according to the first exemplary embodiment.

FIG. 8 is a flowchart where an AP detects transmission noise on a pair of channels A and B during 20-MHz transmission in advance before communication with an

STA according to a second exemplary embodiment.

FIG. 9 is a flowchart where the AP determines whether the pair of channels A and B is STR-capable during 20-MHz transmission according to the second exemplary embodiment.

### DESCRIPTION OF THE EMBODIMENTS

Exemplary embodiments of the present invention will be described in detail below with reference to the attached drawings. Configurations described in the following exemplary embodiments are just examples, and the present invention is not limited to the illustrated configurations.

### Configuration of Wireless Communication System

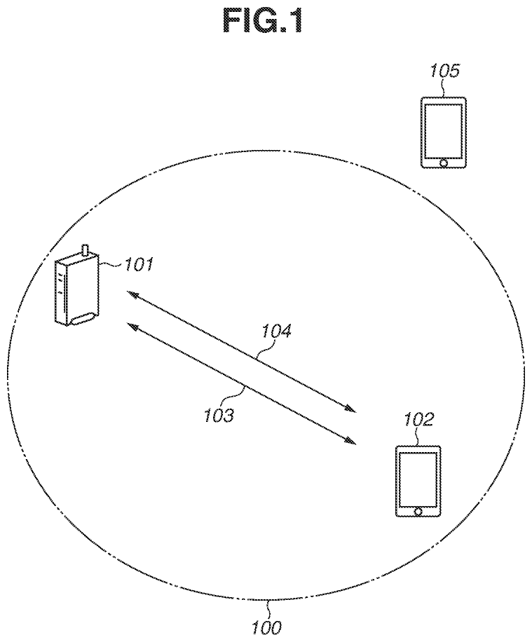

FIG. 1 illustrates a configuration of a network where a communication apparatus 102 (hereinafter, station [STA] 102) according to the present exemplary embodiment participates. The STA 102 is an STA having the role of participating in a wireless network 100. A communication apparatus 101 (hereinafter, access point [AP] 101) is an AP having the role of constructing the wireless network 100. The AP 101 can communicate with the STA 102.

The AP 101 and the STA 102 can both perform wireless communication compliant with the Institute of Electrical and Electronics Engineers (IEEE) 802.11be (Extremely High Throughput [EHT]) standard. The AP 101 and the STA 102 can communicate at 2.4-, 5-, and/or 6-GHz band frequencies. The frequency bands for the communication apparatuses to use are not limited thereto, and other frequency bands, such as a 60-GHz band, may be used. The AP 101 and the STA 102 can communicate using bandwidths of 20, 40, 80, 160, and 320 MHz. The bandwidths for the communication apparatuses to use are not limited thereto, and other bandwidths, such as 240 MHz and 4 MHz, may be used.

The AP 101 and the STA 102 can implement multi-user (MU) communication where signals of a plurality of users are multiplexed by performing orthogonal frequency-division multiple access (OFDMA) communication compliant with the IEEE 802.11be standard. In OFDMA communication, some of the divided frequency bands (resource units [RUs]) are assigned to each STA in a non-overlapping manner so that the carriers of the respective STAs are orthogonal to each other. The AP 101 can thus communicate with a plurality of STAs in parallel within a defined bandwidth.

While the AP 101 and the STA 102 are described to support the IEEE 802.11be standard, legacy standards prior to the IEEE 802.11be may be supported as well. Specifically, the AP 101 and the STA 102 may support at least one of the IEEE 802.11a/b/g/n/ac/ax standards. In addition to the IEEE 802.11 series standards, other communication standards, such as Bluetooth®, near-field communication (NFC), Ultra-wideband (UWB), ZigBee, and MultiBand OFDM Alliance (MBOA) may be supported. UWB includes Wireless Universal Serial Bus (USB), Wireless 1394, and WiNET. Wired communication standards, such as a wired local area network (LAN), may be supported. Specific examples of the AP 101 include, but not limited to, a wireless LAN router, a personal computer (PC), and a smartphone. The AP 101 may be a wireless chip or other information processing device capable of performing wireless communication compliant with the IEEE 802.11be standard. Specific examples of the STA 102 include, but not limited to, a camera, a tablet, a smartphone, a PC, a mobile phone, a video camera, and a headset. The STA 102 may be a wireless chip or other information processing device capable of performing wireless communication compliant with the IEEE 802.11be standard.

The AP 101 and the STA 102 according to the present exemplary embodiment establish links via a plurality of frequency channels and perform multi-link communication. The IEEE 802.11 series standards define channels in bandwidths of 20 MHz. As employed herein, a channel refers to a frequency channel defined in the IEEE 802.11 series standards. The IEEE 802.11 series standards define a plurality of channels in each of the 2.4-, 5-, 6-, and 60-GHz frequency bands. Adjoining channels may be connected or bonded to use a bandwidth of 40 MHz or wider for a single channel. For example, the AP 101 can establish a link and communicate with the STA 102 via a first channel in the 2.4-GHz band. The STA 102 can establish a link and communicate with the AP 101 via a second channel in the 5-GHz band in parallel. In such a case, the STA 102 performs multi-link communication using a link 103 and a link 104, where the second link via the second channel is maintained in parallel with the link via the first channel. The AP 101 can thus improve the throughput of the communication with the STA 102 by establishing links via a plurality of channels with the STA 102.

In multi-link communication, the communication apparatuses may establish a plurality of links of different frequency bands. For example, the AP 101 and the STA 102 may establish a third link in the 5-GHz band in addition to a first link in the 2.4-GHz band and a second link in the 6-GHz band. Alternatively, links may be established via a plurality of different channels within the same frequency band. For example, with a 6-ch link in the 2.4-GHz band as a first link, a 1-ch link in the 2.4-GHz band may be established as a second link. There may be a plurality of links in the same frequency band and a link in a different frequency band. For example, the AP 101 and the STA 102 may establish a 1-ch link in the 2.4-GHz band and a 149-ch link in the 5-GHz band in addition to a 6-ch link in the 2.4-GHz band. By establishing a plurality of connections of different frequencies with the STA 102, the AP 101 can establish communication with the STA 102 in one frequency band (e.g., 5-GHz band) even if another frequency band (e.g., 2.4-GHz band) is congested. This can prevent a drop in the throughput of the communication with the STA 102 and communication delays.

The wireless network 100 in FIG. 1 includes an AP and an STA. However, the numbers and arrangement of APs and STAs are not limited thereto. For example, one or more STAs may be added to the wireless network 100 in FIG. 1. Here, the number of links to be established and the frequency bands and bandwidths of the respective links may vary from one STA to another.

In performing multi-link communication, the AP 101 and the STA 102 divide a piece of data and transmit the divided pieces of data to the other via a plurality of links. The AP 101 and the STA 102 may also be capable of multiple-input and multiple-output (MIMO) communication. In such a case, the AP 101 and the STA 102 include a plurality of antennas, and one transmits different signals from the respective antennas using the same channel. The receiving apparatus simultaneously receives all the signals having arrived from the plurality of streams using the plurality of antennas, and separate and decode the signals of the respective streams. By thus performing MIMO communication, the AP 101 and the STA 102 can communicate a large amount of data in the same time, as compared to without MIMO communication. In performing multi-link communication, the AP 101 and the STA 102 may perform MIMO communication using some or all of the links.

### Configuration of AP and STA

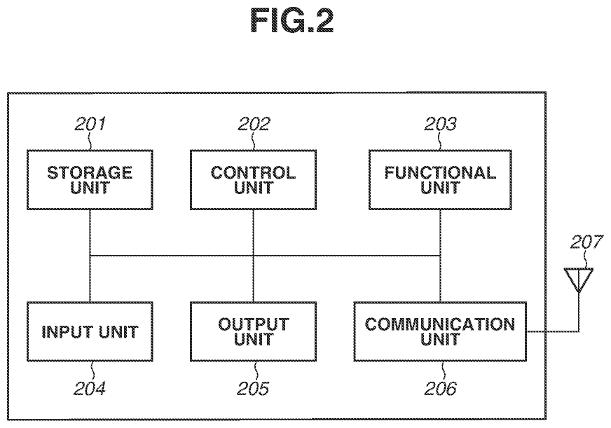

FIG. 2 illustrates a hardware configuration example of the AP 101 according to the present exemplary embodiment. The AP 101 includes a storage unit 201, a control unit 202, a functional unit 203, an input unit 204, an output unit 205, a communication unit 206, and an antenna 207. The AP 101 may include a plurality of antennas.

The storage unit 201 includes one or more memories, such as a read-only memory (ROM) and a random access memory (RAM), and stores computer programs for performing various operations to be described below and various types of information, such as communication parameters for wireless communication. Aside from the memories such as a ROM and a RAM, recording media, such as a flexible disk, a hard disk, an optical disc, a magneto-optical disc, a compact disc read-only memory (CD-ROM), a compact disc-recordable (CD-R), a magnetic tape, a nonvolatile memory card, and a Digital Versatile Disc (DVD) may be used as the storage unit 201. The storage unit 201 may include a plurality of memories.

The control unit 202 includes one or more processors such as a central processing unit (CPU) and a microprocessor unit (MPU), for example. The control unit 202 controls the entire AP 101 by executing the computer programs stored in the storage unit 201. The control unit 202 may be configured to control the entire AP 101 through cooperation of the computer programs and an operating system (OS) stored in the storage unit 201. The control unit 202 generates data and signals (wireless frames) to be transmitted during communication with another communication apparatus. The control unit 202 may include a plurality of processors like a multi-core processor, and the plurality of processors may control the entire AP 101.

The control unit 202 controls the functional unit 203 to perform predetermined processing, such as wireless communication, imaging, printing, and projection. The functional unit 203 is hardware for the AP 101 to perform the predetermined processing.

The input unit 204 accepts various operations from a user. The output unit 205 makes various types of output to the user via a monitor screen and a speaker. Examples of the output by the output unit 205 may include display on the monitor screen, sound output from the speaker, and vibration output. The input unit 204 and the output unit 205 may both be implemented by a single module like a touchscreen. The input unit 204 and the output unit 205 each may be integral with or separate from the AP 101.

The communication unit 206 controls wireless communication compliant with the IEEE 802.11be standard. In addition to the IEEE 802.11be standard, the communication unit 206 may control wireless communication compliant with other IEEE 802.11 series standards and/or wired communication, such as wired LAN communication. The communication unit 206 controls the antenna 207 to transmit and receive signals for wireless communication generated by the control unit 202.

If the AP 101 supports the NFC standard and/or the Bluetooth® standard in addition to the IEEE 802.11be standard, the communication unit 206 may control wireless communication compliant with such communication standards. If the AP 101 can perform wireless communication compliant with a plurality of communication standards, communication units and antennas corresponding to the respective communication standards may be individually included. The AP 101 communicates data, such as image data, document data, and video data, with the STA 102 via the communication unit 206. The antenna 207 may be configured as a member separate from the communication unit 206, or integrated into a single module with the communication unit 206.

The antenna 207 is an antenna capable of 2.4-, 5-, and 6-GHz band communication. In the present exemplary embodiment, the AP 101 is described to include an antenna. However, the AP 101 may include three antennas. The AP 101 may include antennas for respective different frequency bands. If the AP 101 includes a plurality of antennas, communication units 206 corresponding to the respective antennas may be included. The STA 102 has a hardware configuration similar to that of the AP 101.

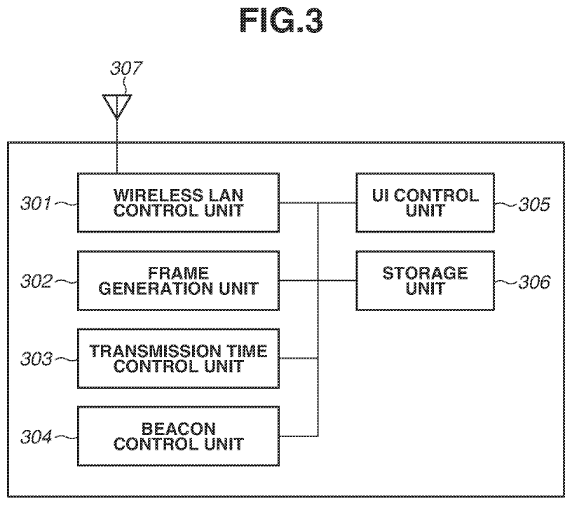

FIG. 3 is a block diagram illustrating a functional configuration of the AP 101 according to the present exemplary embodiment. The STA 102 has a similar functional configuration. Here, the AP 101 includes a wireless LAN control unit 301. The number of wireless LAN control units is not limited to one, and may be two, three, or more. The AP 101 further includes a frame generation unit 302, a transmission time control unit 303, a beacon control unit 304, a user interface (UI) control unit 305, a storage unit 306, and a wireless antenna 307.

The wireless LAN control unit 301 includes the wireless antenna 307 and a circuit for transmitting and receiving wireless signals to/from another wireless LAN apparatus, and programs for controlling the wireless antenna 307 and the circuit. The wireless LAN control unit 301 controls wireless LAN communication based on frames generated by the frame generation unit 302 in compliance with the IEEE 802.11 standard series.

The frame generation unit 302 generates wireless control frames (frames) for the wireless LAN control unit 301 to transmit. The content of the wireless control frames for the frame generation unit 302 to generate may be limited by settings stored in the storage unit 306. The wireless control frames may be modified by user settings from the UI control unit 305. Information about the generated frames is transmitted to the wireless LAN control unit 301 and to the communication partner.

The transmission time control unit 303 controls the timing of issuance of instructions to transmit frames based on a time interval received from the beacon control unit 304. The wireless LAN control unit 301 transmits the frames generated by the frame generation unit 302 based on the instructions from the transmission time control unit 303.

The beacon control unit 304 instructs the frame generation unit 302 and the transmission time control unit 303 about the timing of transmission of a beacon and information to be included in the beacon. When the AP 101 starts its operation as an AP, the beacon control unit 304 sets the time interval at which the transmission time control unit 303 regularly transmits a beacon. The beacon control unit 304 also instructs the frame generation unit 302 about the content to be included in the beacon when the transmission time generation unit 303 issues an instruction to transmit the beacon. The frame generation unit 302 obtains information from the storage unit 306 based on the instruction.

The UI control unit 305 includes UI-related hardware for accepting operations made by the not-illustrated user of the AP 101 on the AP 101, such as a touchscreen and a button, and programs for controlling the hardware. The UI control unit 305 also has functions of presenting information to the user, such as displaying an image and outputting sound.

The storage unit 306 is a storage device that can include a ROM and a RAM for storing programs and data for the AP 101 to operate with.

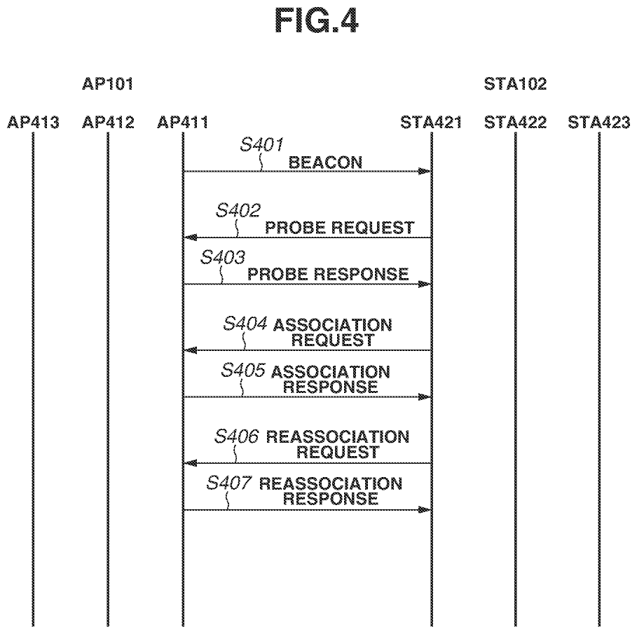

FIG. 4 illustrates a sequence diagram according to a first exemplary embodiment where the AP 101 notifies the STA 102 of channel distances of simultaneous transmit and receive (STR)-capable links on association candidate channels. In this sequence, the notification will be described to be issued by using an Association Response frame. STR is defined in the IEEE 802.11 standard. STR refers to an operation where one link in a link pair used for multi-link communication performs transmission while the other performs reception (or vice versa).

The AP 101 and the STA 102 include wireless LAN control units 301 corresponding to a plurality of respective links. In FIG. 4, an AP 411 of the AP 101 represents a wireless LAN control unit 301 for a first link, an AP 412 a wireless LAN control unit 301 for a second link, and an AP 413 a wireless LAN control unit 301 for a third link. An STA 421 of the STA 102 represent a wireless LAN control unit 301 for the first link, an STA 422 a wireless LAN control unit 301 for the second link, and an STA 423 a wireless LAN control unit 301 for the third link. For example, in the present exemplary embodiment, the STA 421 and the AP 411 perform communication processing via 1-ch of the 2.4-GHz band. The STA 422 and the AP 412 perform communication processing via 5-ch of the 2.4-GHz band. The STA 423 and the AP 413 perform communication processing via 10-ch of the 2.4-GHz band.

The AP 101 and the STA 102 each start the processing of this sequence in response to power-on. Alternatively, at least either one of the AP 101 and the STA 102 may start the processing in response to issuance of an instruction to start multi-link communication by the user or an application. Alternatively, at least either one of the AP 101 and the STA 102 may start the processing when the amount of data to be communicated with the other apparatus reaches or exceeds a predetermined threshold.

In step S401, the AP 101 initially notifies STAs nearby of network information about the own apparatus by transmitting a beacon including the network information about the own apparatus on 1-ch. Specifically, the network information includes a transmission interval at which the AP 101 transmits a beacon, and a service set identifier (SSID) of the AP 101. The AP 101 may also include, as network information, capability information about the AP 101 concerning multi-link communication into the beacon for notification.

In step S402, upon receiving the beacon transmitted from the AP 101 on 1-ch, the STA 102 transmits a Probe Request frame on 1-ch to inquire network information about the AP 101. The Probe Request frame includes the SSID of the AP 101. The STA 102 also includes capability information about the STA 102 concerning multi-link communication into the Probe Request frame to notify the AP 101 of the capability information.

In step S403, upon receiving the Probe Request frame, the AP 101 transmits a Probe Response frame to the STA 102 on 1-ch as a response. If the AP 101 does not include the capability information concerning multi-link communication in the beacon, the AP 101 here includes the capability information into the Probe Response frame and transmits the Probe Response frame. Alternatively, the AP 101 may include only a part of the capability information concerning multi-link communication in the beacon, and the rest or all of the capability information in the Probe Response frame.

The AP 101 and the STA 102 can exchange their capability information concerning multi-link communication by performing the processing of steps S401 to S403.

In step S404, the STA 102 transmits an Association Request frame serving as a connection request for the network formed by the AP 101, to the AP 101 on 1-ch. Here, the STA 102 may include and notify the capability information about the STA 102 concerning multi-link communication into the Association Request frame. The STA 102 may determine the capability information to be transmitted in step S404 based on the capability information about the AP 101 concerning multi-link communication, detected in at least either of steps S401 and S403. For example, suppose that the STA 102 can combine links in the 2.4- and 5-GHz bands while the AP 101 supports only multi-link communication using a plurality of links in the 2.4-GHz band. In such a case, the STA 102 may transmit only capability information about establishment of a plurality of links in the 2.4-GHz band as the capability information to be transmitted in this step. In the present exemplary embodiment, the STA 102 is described to transmit the capability information about the own apparatus concerning multi-link communication in step S402. However, this is not restrictive, and the STA 102 may transmit the capability information not in step S402 but only in this step. Alternatively, the STA 102 may include request information to be requested in performing multi-link communication into the Association Request frame. The request information requested by the STA 102 may be expressed using the capability information concerning multi-link communication or another element.

In step S405, upon receiving the Association Request frame, the AP 101 transmits an Association Response frame to the STA 102 on 1-ch as a response. The Association Response frame transmitted here includes an STR-capable channel distance at each of one or more transmission bandwidths. An STR-capable channel distance is information indicating a distance on a frequency axis at which a plurality of links used in multi-link communication can perform transmission and reception in parallel, i.e., is capable of STR. In other words, the STR-capable channel distance refers to a distance on the frequency axis between frequency channels used for a plurality of respective links used in multi-link communication.

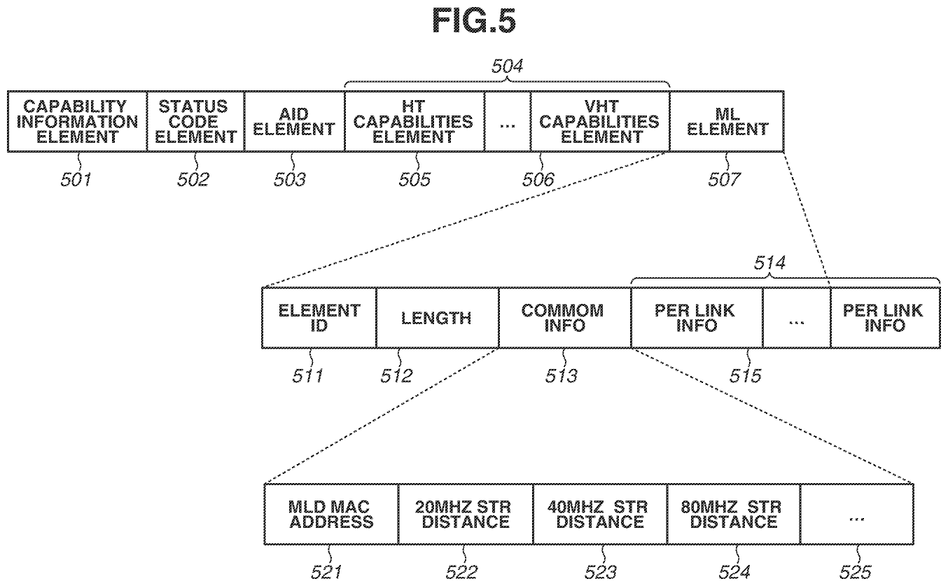

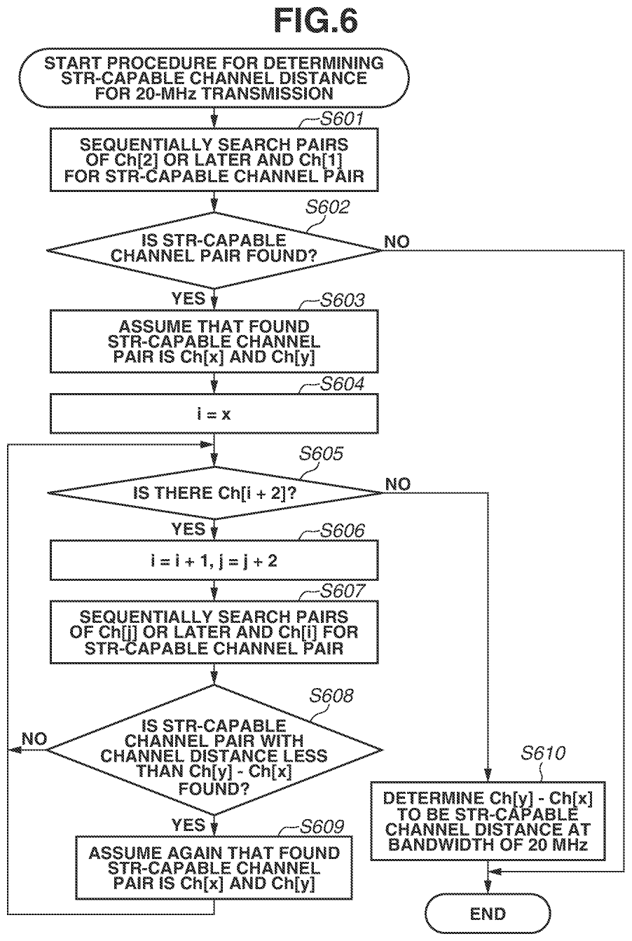

For example, if STR can be performed between links separated by five channels, the STR-capable channel distance is 5 (or five channels). This value varies from one apparatus to another. In the present exemplary embodiment, the STR-capable channel distance of the AP 101 is five channels at a bandwidth of 20 MHz, 10 channels at a bandwidth of 40 MHz, 20 channels at a bandwidth of 80 MHz, and 40 channels at a bandwidth of 160 MHz. The STR-capable channel distance at a bandwidth of 20 MHz may be the only STR-capable channel distance. STR-capable channel distances at bandwidths other than the foregoing, like a bandwidth of 320 MHz, may additionally be included. Exactly how to include the STR-capable channel distances into the Association Response frame will be described below with reference to FIG. 5. A method for determining an STR-capable channel distance will be described below with reference to FIG. 6.

In the present exemplary embodiment, the timing to determine the STR-capable channel distances is immediately before the transmission of the Association Response frame. The timing is not limited to immediately before the transmission of the Association Response frame, and may be upon reception of the Probe Request frame or before issuance of a beacon. The timing may be when a change in a communication state is detected. Other examples may include when the transmission power of the AP 101 changes, when the transmission power of the STA 102 changes, when a packet loss rate increases or decreases during communication, and when a packet error rate increases or decreases during communication. Alternatively, the STR-capable channel distances may be determined on a regular basis. If all pairs of association candidate channels are capable of STR, the STR-capable channel distances at the respective transmission bandwidths do not need to be notified. If all the channel pairs are incapable of STR, the STR-capable channel distances at the respective transmission bandwidths do not need to be notified.

The Association Response frame transmitted here includes operational information in performing multi-link communication with the STA 102, determined by the AP 101. If an Association Request frame including operational information requested by the STA 102 is transmitted in step S404, the AP 101 may transmit an Association Response frame including information about whether to approve the request.

Receiving the Association Response frame, the STA 102 can detect simultaneous transmission and reception performance of the association candidate links apparent to the AP 101 based on the STR-capable channel distances at the respective transmission bandwidths, included in the Association Response frame. Specifically, the AP 101 determines a channel pair to be capable of simultaneous transmission and reception if the channels are separated by the STR-capable channel distance at the transmission bandwidth. For example, suppose that association candidate links are 1-ch, 5-ch, and 6-ch, and the STR-capable channel distance at a bandwidth of 20 MHz is 5. The AP 101 then determines that the pair of 1-ch and 6-ch separated by five channels is capable of performing 20-MHz transmission on one link while performing 20-MHz reception on the other. By contrast, the AP 101 determines the pair of 1-ch and 5-ch with a channel distance of less than five channels is not capable of performing 20-MHz transmission on one link while performing 20-MHz reception on the other. For example, suppose that association candidate links are 1-ch, 10-ch, and 36-ch, and the STR-capable channel distance at a bandwidth of 40 MHz is 10. The AP 101 then determines that the pair of 10-ch and 36-ch separated by 26 channels is capable of performing 40-MHz transmission on one link while performing 20-MHz reception on the other. By contrast, the AP 101 determines the pair of 1-ch and 10-ch with a channel distance of less than 10 channels is not capable of performing 40-MHz transmission on one link while performing 20-MHz reception on the other. In this example, the reception bandwidth is fixed to 20 MHz while the transmission bandwidth is not 20 MHz (is 40 MHz). However, the determination may be made with the reception bandwidth the same as the transmission bandwidth. For example, suppose that association candidate links are 1-ch, 10-ch, and 36-ch, and the STR-capable channel distance at a bandwidth of 40 MHz is 10. The AP 101 then determines that the pair of 10-ch and 36-ch separated by 26 channels is capable of performing 40-MHz transmission on one link while performing 40-MHz reception on the other. By contrast, the AP 101 determines that the pair of 1-ch and 10-ch with a channel distance of less than 10 channels is not capable of performing 40-MHz transmission on one link while performing 40-MHz reception on the other.

In step S406, the STA 102 transmits a Reassociation Request frame to the AP 101 for the purpose of modifying the association content determined by the Association Response frame. For example, suppose that 1-ch, 5-ch, and 10-ch are associated by the Association Response frame, and 1-ch and 5-ch are determined to be incapable of STR because the STR-capable channel distance at a bandwidth of 20 MHz is 5. To ameliorate this, the STA 102 transmit a request for reassociation of 1-ch, 6-ch, and 11-ch to the AP 101, for example. Alternatively, the STA 102 may transmit a Disassociation frame instead of the Reassociation Request frame. Alternatively, the STA 102 may simply transmit data without transmitting the Reassociation Request frame. In such a case, synchronous control to prevent transmission on one channel during reception on the other, or control to detect a packet reception leak and retry transmission, may be desirable for the sake of accurate reception since 1-ch and 5-ch are not capable of simultaneous transmission and reception. Alternatively, the STA 102 performs processing such that the channel pair incapable of simultaneous transmission and reception is used for communication of low priority or communication where accurate reception is not needed. For example, the STA 102 changes traffic identifier (TID) allocation.

FIG. 5 illustrates an example of a configuration of an Association Response frame that the AP 101 transmits to the STA 102. A Capability Information element 501 indicates optional functions requested or optional functions supported by the own apparatus. A Status Code element 502 indicates whether the request to be responded is successful or failed. An Association Identifier (AID) element 503 indicates an AID assigned by the AP 101. Capability information 504 indicates the Capability information about the channel where the AP 101 transmits the Association Response frame. For example, in performing communication compliant with the IEEE 802.11n, the Capability information 504 includes a High Throughput (HT) Capabilities element 505. In performing communication compliant with the IEEE 802.11ac, the Capability information 504 includes a Very High Throughput (VHT) Capabilities element 506. However, the Capability information 504 is not limited thereto.

A Multi-Link (ML) element 507 is information indicating that ML communication is supported. The ML element 507 is not included in the Association Response frame if the AP does not support ML communication. The ML element 507 includes an Element ID field 511 for identifying an element, a Length field 512 indicating the data length of the element, and information specific to the element. The information specific to the element includes a Common Info field 513 containing information common with all links and Per Link Info fields 514 containing information specific to the respective links.

Fields 521 to 525 indicate information included in a Common Info field 513. A Multi-Link Device (MLD) medium access control (MAC) Address field 521 indicates an MLD MAC address of the AP 101. A 20 MHz STR Distance field 522 indicates an STR-capable channel distance that is the channel-to-channel distance where channels are capable of STR at a transmission bandwidth of 20 MHz. For example, if the value stored here is 5 and two channels are separated by five channels or more, the AP 101 can perform 20-MHz transmission on one of the channels while performing 20-MHz reception on the other. A 40 MHz STR Distance field 523 indicates the channel-to-channel distance where channels are capable of STR at a transmission bandwidth of 40 MHz. For example, if the value stored here is 10 and two channels are separated by 10 channels or more, the AP 101 can perform 40-MHz transmission on one of the channels while performing 20-MHz reception on the other. An 80 MHz STR Distance field 524 indicates the channel-to-channel distance where channels are capable of STR at a transmission bandwidth of 80 MHz. For example, if the value stored here is 20 and two channels are separated by 20 channels or more, the AP 101 can perform 80-MHz transmission on one of the channels while performing 20-MHz reception on the other. Other bandwidth fields, such as a 160 MHz STR Distance field, may be included. Information about wide bandwidths not supported by the AP 101 may be omitted. While the STR Distance fields are described to indicate channel-to-channel distances (channels), the STR Distance fields may indicate frequency-to-frequency distances (Hz). Moreover, while the reception bandwidth during simultaneous transmission and reception is fixed to 20 MHz, the reception bandwidth may be the same as the transmission bandwidth. Specifically, the AP 101 may perform transmission at a bandwidth of 40 MHz while performing reception at a bandwidth of 40 MHz (the same applies to 80 MHz and 160 MHz).

By including such pieces of information into the Association Response frame, the AP 101 can notify the STA 102 that ML communication is supported and of the STR-capable channel distances at the respective transmission bandwidths. The names, bit positions, and sizes of the fields are not limited to the foregoing example, and similar information may be stored with different field names, in different order, and/or in different sizes.

FIG. 6 is a flowchart for determining the STR-capable channel distance for 20-MHz transmission of the AP 101. This flowchart is implemented by the processor(s) of the control unit 202 of the AP 101 executing a program stored in the storage unit 201.

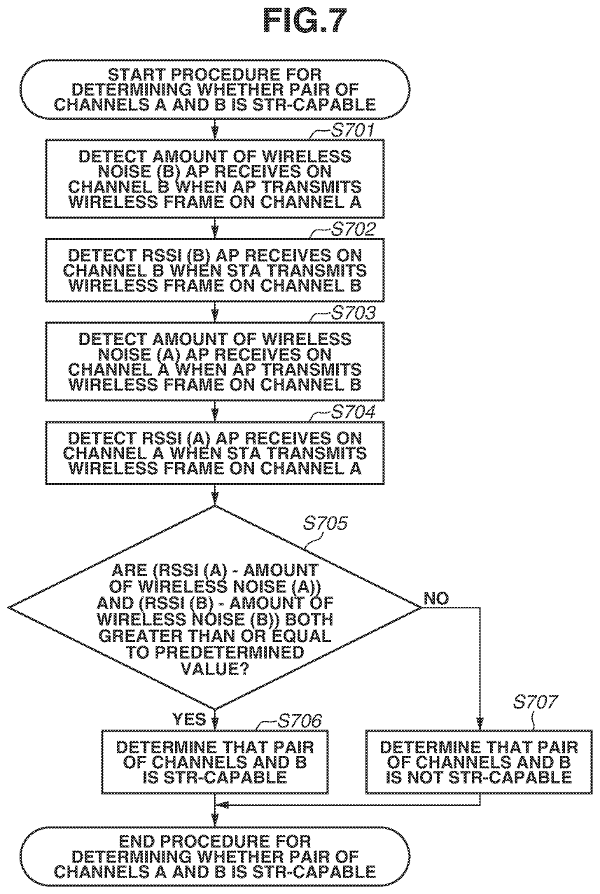

In step S601, the AP 101 sequentially searches pairs of Ch[2] or later and Ch[1] for an STR-capable channel pair. As employed herein, Ch[n] represents a channel of the nth lowest frequency among association candidate channels capable of communication in a bandwidth of 20 MHz. In the present exemplary embodiment, suppose that an association candidate channel group includes 1-ch, 5-ch, 10-ch, 36-ch, 40-ch, 64-ch, and 100-ch. Here, Ch[1] represents 1-ch, and Ch[7] represents 100-ch. In such a case, the AP 101 checks whether the pair of 1-ch and 5-ch is STR-capable. If not, the AP 101 checks whether the pair of 1-ch and 10-ch is STR-capable. The AP 101 successively checks the pairs up to Ch[1] and Ch[7]. A method for determining whether a given channel pair is STR-capable for 20-MHz transmission will be described below with reference to FIG. 7. In the present exemplary embodiment, suppose that 1-ch and 10-ch are determined to be STR-capable.

In step S602, the AP 101 determines whether an STR-capable channel pair is found in step S601. If an STR-capable channel pair is found (YES in step S602), the processing proceeds to step S603. If not (NO in step S602), the AP 101 determines that there is no STR-capable channel distance at a bandwidth of 20 MHz, or the value of the STR-capable channel distance is unrealistically large, and the processing ends. In the present exemplary embodiment, the processing proceeds to step S603 since the pair of 1-ch and 10-ch is found.

In step S603, the AP 101 assumes that the found STR-capable channel pair is Ch[x] and Ch[y] (here, x<y). In the present exemplary embodiment, x=1 and y=3.

In step S604, the AP 101 assumes i=x. In the present exemplary embodiment, i=1.

In step S605, the AP 101 determines whether there is Ch[i+2] among the association candidate channels capable of 20-MHz communication. If there is such a channel (YES in step S605), the processing proceeds to step S606. If not (NO in step S605), the processing proceeds to step S610. In step S610, the AP 101 determines that the STR-capable channel distance at a bandwidth of 20 MHz is Ch[y]−Cy[x]. The processing ends. In the present exemplary embodiment, since i=1, there is Ch[3] that is 10-ch and the processing proceeds to step S606.

In step S606, the AP 101 assumes i=i+1 and j=i+2. In the present exemplary embodiment, i=2 and j=3.

In step S607, the AP 101 sequentially searches pairs of Ch[j] or later and Ch[i] for an STR-capable channel pair. In the present exemplary embodiment, the AP 101 initially checks whether the pair of Ch[2] and Ch[3], i.e., 5-ch and 10-ch is STR-capable. If not, the AP 101 checks whether the pair of Ch[2] and Ch[4], i.e., 5-ch and 36-ch is STR-capable. The AP 101 successively checks the pairs up to Ch[2] and Ch[7]. In the present exemplary embodiment, Ch[2] and Ch[4] are determined to be STR-capable.

In step S608, the AP 101 determines whether an STR-capable channel pair is found in step S607 and the channel distance of the channel pair is less than Ch[y]−Ch[x]. If an STR-capability channel pair is found and the channel distance is less than Ch[y]−Ch[x] (YES in step S608), the processing proceeds to step S609. If no STR-capability channel pair is found or the channel distance is greater than or equal to Ch[y]−Ch[x] (NO in step S608), the processing proceeds to step S605. In the present exemplary embodiment, the channels found in step S607 have a channel distance of Ch[4]−Ch[2]=36−5=31. Since Ch[y]−Ch[x]=10−1=9, the processing proceeds to step S605 with i=2. Step S605 and the subsequent steps are repeated for i=2 to search for a channel pair that has a smaller channel distance and is capable of STR with Ch[3]. Step S605 and the subsequent steps are thus repeated for the updated i to search for an STR-capable channel pair having a smaller channel distance.

In step S609, the AP 101 assumes that the STR-capable channel pair having a smaller channel distance, found in step S608 is Ch[x] and Ch[y] (here, x<y). In the present exemplary embodiment, suppose that Ch[1] and Ch[3] are eventually determined to be the STR-capable channel pair with the smallest channel distance. However, this channel pair is already identified in step S603, and the processing therefore will not proceed to step S609.

In step S610, the AP 101 determines the channel distance of the STR-capable channel pair found with the smallest channel distance to be the STR-capable channel distance at a bandwidth of 20 MHz. The processing ends.

While this flowchart has been described with a focus on the transmission at the bandwidth of 20 MHz, STR-capable channel distances at bandwidths of 40 MHz and 80 MHz can be determined in a similar manner. An STR-capable channel distance between one channel having a bandwidth of a total of 160 MHz, which is divided into two 80-MHz bands, and another can be determined by checking only the 80-MHz band located closer to another channel. STR-capable channel distances in other divided bands can also be determined in a similar manner.

FIG. 7 illustrates a flowchart for determining whether a pair of channels A and B is STR-capable during 20-MHz transmission of the AP 101. This flowchart is implemented by the processor(s) of the control unit 202 of the AP 101 executing a program stored in the storage unit 201.

In step S701, the AP 101 initially detects the amount of wireless noise (B) the AP 101 receives on channel B when the AP 101 transmits a wireless frame on channel A at a bandwidth of 20 MHz. The amount of wireless noise is in units of dBm, for example. The processing of step S701 may be implemented by detecting the amount of wireless noise at the timing of transmission of a wireless frame, or by transmitting a dummy frame (frame with meaningless data content) on channel A to detect the amount of wireless noise.

In step S702, the AP 101 detects a received signal strength indicator (RSSI) (B) the AP 101 receives on channel B at a bandwidth of 20 MHz when the STA 102 transmits a wireless frame on channel B at a bandwidth of 20 MHz. The RSSI is in units of dBm, for example. The processing of step S702 may be implemented by detecting the RSSI at the timing of transmission of a wireless frame, or by requesting the STA 102 in advance to transmit a dummy frame on channel B to detect the amount of wireless noise.

In step S703, the AP 101 detects the amount of wireless noise (A) the AP 101 receives on channel A when the AP 101 transmits a wireless frame on channel B at a bandwidth of 20 MHz. The processing of step S703 may be implemented by detecting the amount of wireless noise at the timing of transmission of a wireless frame, or by transmitting a dummy frame on channel B to detect the amount of wireless noise.

In step S704, the AP 101 detects an RSSI (A) the AP 101 receives on channel A at a bandwidth of 20 MHz when the STA 102 transmits a wireless frame on channel A at a bandwidth of 20 MHz. The processing of step S704 may be implemented by detecting the RSSI at the timing of transmission of a wireless frame, or by requesting the STA 102 in advance to transmit a dummy frame on channel A to detect the amount of wireless noise.

In step S705, the AP 101 determines whether (RSSI (A)—the amount of wireless noise (A)) and (RSSI (B)—the amount of wireless noise (B)) are both greater than or equal to a predetermined value. If both differences are greater than or equal to the predetermined value (YES in step S705), the processing proceeds to step S706. If at least either of the differences is less than the predetermined value (NO in step S705), the processing proceeds to step S707. The predetermined value here may be a fixed value. The predetermined value may be determined as appropriate based on the communication state. For example, if channel A has a link rate higher than a predetermined rate, the predetermined value to be compared with RSSI (A)—the amount of wireless noise (A) is increased. The reason is that the higher the link rate, the higher signal-to-noise ratio (SNR) is desirable for the sake of high quality communication. The determination of step S705 may be made based on either the RSSIs or the amounts of wireless noise. For example, whether RSSI (A) and RSSI (B) are both higher than or equal to a predetermined value may be determined. Alternatively, whether the amount of wireless noise (A) and the amount of wireless noise (B) are both smaller than or equal to a predetermined value may be determined.

In step S706, the AP 101 determines that the pair of channels A and B is STR-capable. The processing ends. In step S707, the AP 101 determines that the pair of channels A and B is not STR-capable. The processing ends.

The flowchart for determining whether a pair of channels A and B is STR-capable during 20-MHz transmission has been described above. For 40 MHz and 80 MHz, a similar procedure is performed with the transmission wireless bandwidth changed to 40 MHz and 80 MHz, respectively, whereas the reception wireless bandwidth is still 20 MHz. Alternatively, the reception wireless bandwidth may be the same as the transmission wireless bandwidth, or the same as the bandwidth of an association candidate channel. The wider the wireless bandwidth, the lower the SNR can be for high-quality communication. The predetermined value may therefore be changed accordingly.

As described above, in the present exemplary embodiment, the AP 101 transmits an Association Response frame along with the STR-capable channel distances at the respective wireless bandwidths. This enables the STA 102 to infer channel pairs capable of STR and channel pairs not capable of STR during ML communication. For the purpose of efficient communication, the STA 102 can change the channels to be used, establish a new channel, or transmit high priority data on an STR-capable channel. While in the present exemplary embodiment the AP 101 notifies the STA 102 of the STR-capable channel distances at the respective wireless bandwidths, this is not restrictive. The STA 102 may notify the AP 101 of the STR-capable channel distances.

In the present exemplary embodiment, the STR-capable channel distances are included in the Association Response frame. However, this is not restrictive. For example, the STR-capable channel distances may be included in management frames, such as a beacon, Probe Request, Probe Response, Association Request, Authentication, and Action.

In the first exemplary embodiment, the AP 101 is described to measure the amounts of wireless noise and the RSSIs during communication with the STA 102, determines STR-capable channel distances based on the measurements, and notifies the STA 102 of the STR-capable channel distances. In a second exemplary embodiment, a configuration will be described where an AP 101 measures and stores in advance the amounts of wireless noise related to transmission among the amounts of wireless noise and determines STR-capable channel distances during communication with an STA 102 based also on the stored amounts of wireless noise.

What have been described in the first exemplary embodiment with reference to FIGS. 4 to 6 also apply to the second exemplary embodiment. A description thereof will thus be omitted.

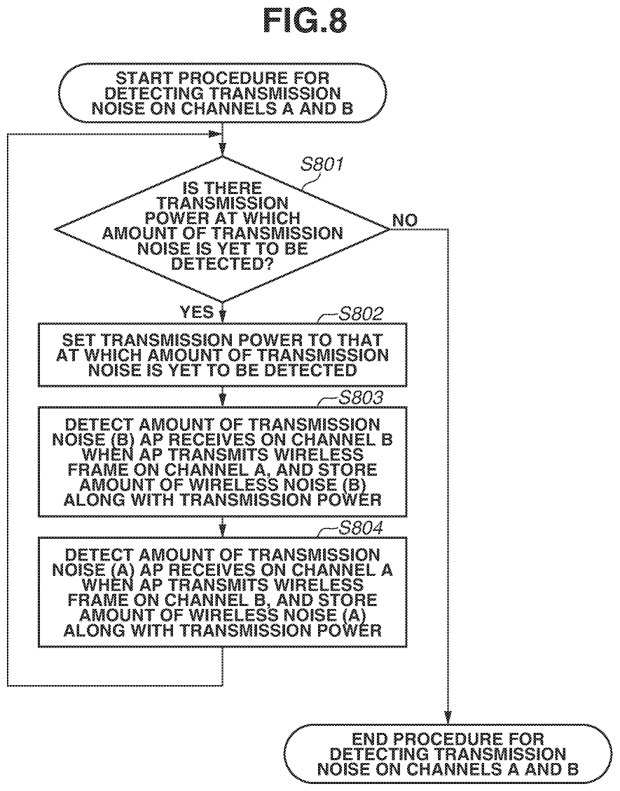

FIG. 8 is a flowchart illustrating processing where the AP 101 detects transmission noise on a pair of channels A and B during 20-MHz transmission in advance before communication with the STA 102. This flowchart is implemented by a processor or processors of a control unit 202 of the AP 101 executing a program stored in a storage unit 201.

In step S801, the AP 101 initially determines whether there is transmission power at which the amount of transmission noise is yet to be detected in steps S803 and S804 to be described below. If there is such transmission power (YES in step S801), the processing proceeds to step S802. If not (NO in step S801), the processing ends. Since the AP 101 is yet to communicate with the STA 102 and the transmission power to the STA 102 is not determined, the AP 101 desirably measures the amounts of transmission noise at all transmission power candidates in advance. If the transmission power to the STA 102 is determined in advance, the processing may skip step S801 and proceed to step S802.

In step S802, the AP 101 sets the transmission power of the wireless LAN control unit 301 to the value of the transmission power at which the amount of transmission noise is yet to be detected, determined in step S801.

In step S803, the AP 101 detects the amount of transmission noise (B) the AP 101 receives on channel B when the AP 101 transmits a wireless frame on channel A at a bandwidth of 20 MHz, and stores the amount of transmission noise (B) into the storage unit 306 along with the transmission power. The amount of transmission noise is in units of dBm, for example. The processing of step S803 may be implemented by detecting the amount of wireless noise at the timing of transmission of a wireless frame, or by transmitting a dummy frame on channel A to detect the amount of wireless noise.

In step S804, the AP 101 detects the amount of transmission noise (A) the AP 101 receives on channel A when the AP 101 transmits a wireless frame on channel B at a bandwidth of 20 MHz, and stores the amount of transmission noise (A) into the storage unit 306 along with the transmission power. The amount of transmission noise is in units of dBm, for example. The processing of step S804 may be implemented by detecting the amount of wireless noise at the timing of transmission of a wireless frame, or by transmitting a dummy frame on channel A to detect the amount of wireless noise.

This processing may be performed after the AP 101 is powered on or before the AP 101 is delivered to the user like before factory shipment. The detection results of another similar apparatus may be copied and stored.

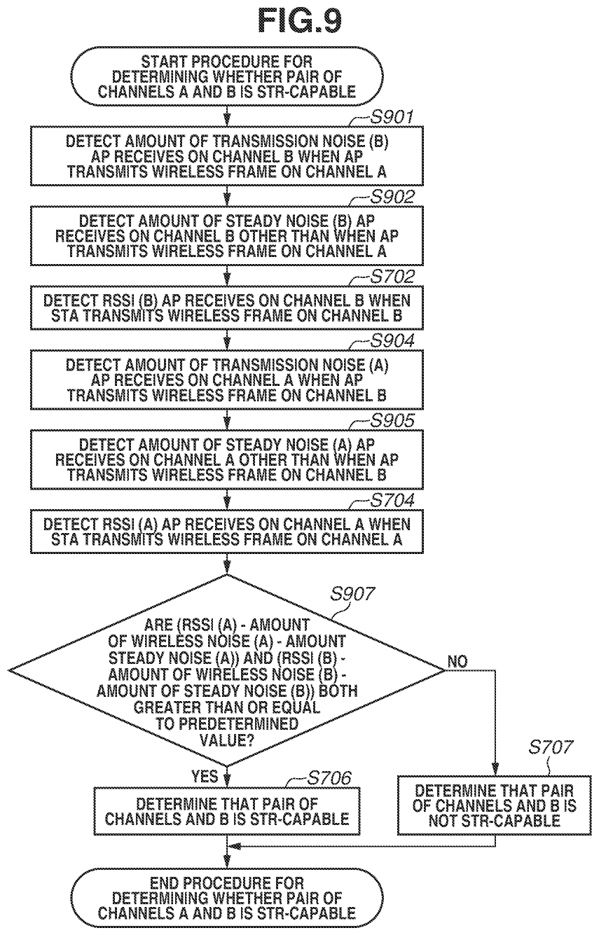

FIG. 9 is a flowchart for determining whether a pair of channels A and B is STR-capable during 20-MHz transmission of the AP 101. This flowchart is implemented by the processor(s) of the control unit 202 of the AP 101 executing a program stored in the storage unit 201.

In step S901, the AP 101 initially detects, from the storage unit 306, the amount of transmission noise (B) the AP 101 receives on channel B when the AP 101 transmits a wireless frame on channel A at a bandwidth of 20 MHz. Here, the AP 101 selects an amount of transmission power (B) in which the transmission power pertaining to the transmission noise (B) matches the currently set transmission power of the AP 101. Alternatively, the transmission power pertaining to the amount of transmission noise (B) may be a value closet to the currently set transmission power of the AP 101 or a minimum value exceeding the currently set transmission power of the AP 101.

In step S902, the AP 101 detects the amount of steady noise (B) the AP 101 receives on channel B at timing other than when the AP 101 transmits a wireless frame on channel A at a bandwidth of 20 MHz.

In step S702, the AP 101 detects the RSSI the AP 101 receives on channel B at a bandwidth of 20 MHz when the STA 102 transmits a wireless frame on channel B at a bandwidth of 20 MHz.

In step S904, the AP 101 detects, from the storage unit 306, the amount of transmission noise (A) the AP 101 receives on channel A when the AP 101 transmits a wireless frame on channel B at a bandwidth of 20 MHz. Here, the AP 101 selects an amount of transmission noise (A) in which the transmission power pertaining to the transmission noise (A) matches the currently set transmission power of the AP 101. Alternatively, the transmission power pertaining to the amount of transmission noise (A) may be a value closest to the currently set transmission power of the AP 101 or a minimum value exceeding the currently set transmission power of the AP 101.

In step S905, the AP 101 detects the amount of steady noise (A) the AP 101 receives on channel A at timing other than when the AP 101 transmits a wireless frame on channel B at a bandwidth of 20 MHz.

In step S704, the AP 101 detects the RSSI the AP 101 receives on channel A at a bandwidth of 20 MHz when the STA 102 transmits a wireless frame on channel A at a bandwidth of 20 MHz.

In step S907, the AP 101 determines whether (RSSI (A)—the amount of transmission noise (A)−the amount of steady noise (A)) and (RSSI (B)—the amount of transmission noise (B)−the amount of steady noise (B)) are both greater than or equal to a predetermined value. If both differences are greater than or equal to the predetermined value (YES in step S907), the processing proceeds to step S706. If at least either of the differences is less than the predetermined value (NO in step S907), the processing proceeds to step S707. The predetermined value here may be a fixed value. The predetermined value may be determined as appropriate based on the communication state. For example, if channel A has a link rate higher than a predetermined rate, the predetermined value to be compared with (RSSI (A)—the amount of wireless noise (A)−the amount of steady noise (A)) is increased. The reason is that the higher the link rate, the higher SNR is desirable for the sake of high quality communication. For simplicity's sake, one or more of the RSSIs, the amounts of transmission noise, and the amounts of steady noise may be assumed to be 0. For example, whether RSSI (A) and RSSI (B) are both higher than or equal to a predetermined value may be determined. Whether the amount of wireless noise (A) and the amount of wireless noise (B) are both greater than or equal to a predetermined value may be determined.

Steps S706 and S707 are similar to those of the first exemplary embodiment. A description thereof will thus be omitted.

The flowchart has been described above for determining whether a pair of channels A and B is STR-capable during 20-MHz transmission. For 40 MHz and 80 MHz, a similar procedure is performed with the transmission wireless bandwidth changed to 40 MHz and 80 MHz, whereas the reception wireless bandwidth is still 20 MHz. Alternatively, the reception wireless bandwidth may be the same as the transmission wireless bandwidth, or the same as the bandwidth of an association candidate channel. The reception wireless bandwidth may be the maximum bandwidth of the association candidate channels, or the minimum bandwidth of the association candidate channels. The wider the wireless bandwidth, the lower the SNR can be for high-quality communication. The predetermined value may therefore be changed accordingly.

As described above, in the present exemplary embodiment, the AP 101 transmits an Association Response frame along with the STR-capable channel distances at the respective wireless bandwidths, determined based also on the amounts of transmission noise measured in advance before communication with the STA 102. This enables the STA 102 to infer channel pairs capable of STR and channel pairs not capable of STR during ML communication. For the purpose of efficient communication, the STA 102 can change the channels to be used, establish a new channel, or transmit high priority data on an STR-capable channel. While in the present exemplary embodiment the AP 101 notifies the STA 102 of the STR-capable channel distances at the respective wireless bandwidths, this is not restrictive. The STA 102 may notify the AP 101 of the STR-capable channel distances.

In the present exemplary embodiment, the STR-capable channel distances are included in the Association Response frame. However, this is not restrictive. For example, the STR-capable channel distances may be included in management frames, such as a beacon, Probe Request, Probe Response, Association Request, Authentication, and Action.

### Other Exemplary Embodiments

The foregoing exemplary embodiments are just examples, and the technical scope of the present invention is not limited thereto. Aside from the foregoing exemplary embodiments, various modifications are also covered by the present invention. While the foregoing exemplary embodiments have been described by using the IEEE 802.11be standard as an example of the wireless LAN standard, various standards including the IEEE 801.11 series legacy standards and successors (IEEE 802.11x) and similar types of other wireless standards are also applicable.

The present invention is not limited to the foregoing exemplary embodiments, and various changes and modifications can be made without departing from the spirit and scope of the present invention. The following claims are therefore attached to make the scope of the present invention public.

The present invention claims the benefit of priority based on Japanese Patent Application No. 2021-096516 filed on Jun. 9, 2021, the entire contents of which are incorporated herein by reference.

According to an exemplary embodiment of the present invention, communication apparatuses can efficiently share information about whether a channel pair is capable of simultaneous transmission and reception during ML communication, and can perform efficient ML communication therebetween.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
a communication unit capable of performing communication of a wireless frame using a first frequency channel and communication of a wireless frame using a second frequency channel in parallel; and
a transmission unit configured to transmit information to another communication apparatus, the information indicating a distance between the first frequency channel and the second frequency channel on a frequency axis, the information indicating a channel distance necessary for performing transmission of the wireless frame using the first frequency channel and reception of the wireless frame using the second frequency channel in parallel in the communication by the communication unit.

2. The communication apparatus according to claim 1, further comprising a determination unit configured to determine the channel distance based on a communication state on the first frequency channel and/or the second frequency channel.

3. The communication apparatus according to claim 2, wherein the determination unit is configured to determine the channel distance based on one or more of values of:
noise caused by transmission using the first frequency channel by the communication apparatus on the second frequency channel of the communication apparatus;
noise detected on the second frequency channel of the communication apparatus when the communication apparatus is not performing the transmission using the first frequency channel;
transmission power detected on the second frequency channel of the communication apparatus due to transmission using the second frequency channel by another communication apparatus;
noise caused by transmission using the second frequency channel by the communication apparatus on the first frequency channel of the communication apparatus;
noise detected on the first frequency channel of the communication apparatus when the communication apparatus is not performing the transmission using the second frequency channel; and
transmission power detected on the first frequency channel of the communication apparatus due to transmission using the first frequency channel by another communication apparatus.

4. The communication apparatus according to claim 3, wherein the value of the noise caused by the transmission using the first frequency channel by the communication apparatus on the second channel of the communication apparatus and the value of the noise caused by the transmission using the second frequency channel by the communication apparatus on the first frequency channel of the communication apparatus are stored in the communication apparatus in advance.

5. The communication apparatus according to claim 3, wherein the value of the noise caused by the transmission using the first frequency channel by the communication apparatus on the second frequency channel of the communication apparatus and the value of the noise caused by the transmission using the second frequency channel by the communication apparatus on the first frequency channel of the communication apparatus are measured by the communication apparatus transmitting the wireless frames.

6. A communication apparatus comprising:
a communication unit capable of performing communication of a wireless frame using a first frequency channel and communication of a wireless frame using a second frequency channel in parallel; and
a reception unit configured to receive information from another communication apparatus, the information indicating a distance between the first frequency channel and the second frequency channel on a frequency axis, the information indicating a channel distance necessary for performing transmission of the wireless frame using the first frequency channel and reception of the wireless frame using the second frequency channel in parallel in the communication by the communication apparatus.

7. The communication apparatus according to claim 6, wherein a frequency channel for the communication apparatus to communicate on is determined based on the information indicating the channel distance, received by the reception unit.

8. The communication apparatus according to claim 1, wherein the communication unit is configured to perform wireless communication compliant with an Institute of Electrical and Electronics Engineers (IEEE) 802.11 standard.

9. The communication apparatus according to claim 1, wherein the communication unit is configured to perform multi-link communication defined in an IEEE 802.11 standard.

10. The communication apparatus according to claim 1, wherein the channel distance is a channel-to-channel distance, on the frequency axis, necessary for performing simultaneous transmit and receive (STR) communication defined in an IEEE 802.11 standard.

11. The communication apparatus according to claim 1, wherein the first frequency channel and the second frequency channel are different frequency channels in a same frequency band.

12. The communication apparatus according to claim 1, wherein the first frequency channel and the second frequency channel are channels in different frequency bands.

13. A communication method comprising:
performing communication capable of communicating a wireless frame using a first frequency channel and communicating a wireless frame using a second frequency channel in parallel; and
transmitting information to another communication apparatus, the information indicating a distance between the first frequency channel and the second frequency channel on a frequency axis, the information indicating a channel distance necessary for performing transmission of the wireless frame using the first frequency channel and reception of the wireless frame using the second frequency channel in parallel in the communication.

14. A communication method of a communication apparatus, the communication method comprising:
performing communication capable of communicating a wireless frame using a first frequency channel and communicating a wireless frame using a second frequency channel in parallel; and
receiving information from another communication apparatus, the information indicating a distance between the first frequency channel and the second frequency channel on a frequency axis, the information indicating a channel distance necessary for performing transmission of the wireless frame using the first frequency channel and reception of the wireless frame using the second frequency channel in parallel in the communication.

15. A storage medium storing a program for causing a computer to operate as the communication apparatus according to claim 1.
